(19) United States
(12) Patent Application Publication
(10) Pub. No.: US 2008/0255811 A1
(43) Pub. Date: Oct. 16, 2008

(54) System and Method for Determining Surface Roughness

(76) Inventors: Zi Qiang Sheng, Olmsted Twp., OH (US); Michael Strazzanti, Gates Mills, OH (US)

Correspondence Address: JEANNE E. LONGMUIR, 2836 CORYDON ROAD, CLEVELAND HEIGHTS, OH, 44118, US

(21) Appl. No.: 12/102,850

(22) Filed: Apr. 14, 2008

Related U.S. Application Data
(60) Provisional application No. 60/911,765, filed on Apr. 13, 2007.

(51) Int. Cl. G06F 17/50

(52) U.S. Cl. 703/1

(57) ABSTRACT

The present application provides a method and system for modeling surface roughness or cosmetic appearance as the result of manufacturing process performed on metal products. The method and system include loading of the desired dimensions of a metal product to be manufactured into a computer aided design program. A computer aided design model of the metal product to be manufactured is then generated, and the predicted levels of strain associated with manufacture of the metal product are also generated. A database of the characteristics of the metal material used in the manufacturing process is also created, including a digital image, resulting from physical testing of different desired materials to form the product to be manufactured. A database of physical characteristics created from physical testing performed using the computer aided design model of the product to be manufactured from a desired material is also created and used to produce a simulated product image which has the physical characteristics resulting from the manufacturing process superimposed on the simulated product image. The simulated product image may then be reviewed to determine whether potential problem areas may result in the metal product during manufacturing of the metal product from the desired metal material.

### CROSS-REFERENCE TO RELATED APPLICATIONS AND INFORMATION

The present application claims priority from U.S. Patent Application Ser. No. 60/911,765, filed Apr. 13, 2007, the entire subject matter of which is incorporated herein by reference. The patent or application file contains at least one drawing executed in color. Copies of this patent or patent application publication with color drawings(s) will be provided by the Office upon request and payment of the necessary fee.

### BACKGROUND OF THE INVENTION

1. Field of Invention

The present invention relates to an improved modeling system for manufacturing and more specifically for an improved system and method for determining surface roughness or cosmetic appearance using computer modeling in connection with manufacturing of a metal product.

2. Background of the Related Art

In the past, the manufacture or forming of metal products makes use of metal drawing processes, during which a sheet of metal material, for example, is drawn in a number of incremental steps, to form the final metal product. Conventional design of the tools used to perform the metal drawing operation included estimation from experience based knowledge, and a lengthy development process. The development process was simply a trial and error method of determining the ideal geometry, material type, lubricant and other manufacturing process components for a successful metal forming operation. The process is time intensive and costly as changes to the tooling geometry must be made repeatedly, resulting in a great deal of waste product, until a successful metal drawing operation and an acceptable final product is developed.

More recently, metal products manufacturers have used computer aided design and computer aided manufacturing processes to model product prior to manufacturing, as a means to reduce the manufacturing process cost and improve product quality. Unfortunately, while a product may have the desired physical shape, some trial and error has still been required to obtain the desired cosmetic appearance required for the final metal product, particularly in connection with metal products having exterior surfaces with high visibility and rigorous cosmetic or optical reflectivity requirements.

### SUMMARY OF THE INVENTION

Software models of the products to be manufactured have previously made use of finite element analyses (FEA), which are conducted using finite element methods (FEM). In the present application, an initial product model is provided from commercially available computer aided design (CAD) software modeling programs. A finite element analyses using finite element methods is then conducted to create a database or network of mesh elements and nodes modeled on the three dimensional data of the product to be manufactured. Physical properties of these database elements are then set as parameters, and a numerical analysis is performed by a computer to determine the impact of external physical forces on the mesh elements.

These simulations are particularly valuable in the manufacture of metal products in the metalforming industry. A simulation of a steel sheet, for example, is created within the database of mesh elements based on its known physical properties, and the mesh elements may then be subjected to simulated forces experienced by the steel sheet during the metalforming processes. These simulations allow designers and engineers to see the benefits and drawbacks of subjecting the sheet steel, or other metal material to be formed, as applied to the network or database of mesh elements, during various aspects of the metalforming process design proposed for manufacture of the metal products. For example, in the metal drawing process, where flat steel sheets or strips are formed into spherical or box shaped cups, the finite element method has been proven to be very useful.

The use of an FEM simulation of the type described allows for much more flexibility and reduced cost in the product development cycle. Essentially, the metalforming tool may be developed virtually as a computer model before the physical tool is created. The engineer may change the parameters of the simulation and geometric models of the tooling and runs repeated simulations of the metalforming process until an acceptable simulated product model is obtained. This process is repeated much in the same way as conventional development; however, the fabrication costs and waste are eliminated. The reduction in time and cost by developing metal drawing processes and operations using the method of this application can be as much as 50%.

The FEM simulations described provide a predictive visual model of the results of the forming process on the simulated mesh elements. These results are produced by the post-processor of the commercial FEM software. The FEM software can produce a network of mesh elements which shows localized strain levels associated with each element. By correlating such strain levels to the known limits of the steel or other metal materials ability to deform, the engineer can determine whether the forming process will be successful or fail when performed on the physical metal materials used for metalforming of the product. The present method makes use of the predicted strain levels based on real world test data collected from controlled experiments.

The FEA/FEM process used in the present application includes three main components. First, a pre-processing step is performed during which the network of mesh elements to be simulated, and the related forces which will affect that simulation, are created. Second, a solution step is performed, during which a series of computations are made which simulate the interaction of the metal forming forces or tools with the mesh elements defined in the pre-processing step. Third, in the final post-processing step, the results of the simulated interaction between the metal forming forces and the mesh elements simulating the metal product being formed, are converted into interpretable data.

Such data usually makes use of a color coded, three dimensional image or other visual model. If the model data is shown as a red area, this indicates that the part is being formed is on the edge of reliability, or may be unreliable. Any significant change in the forming process and the part may fail in that area. Yellow areas are considered more reliable, but may still have risk. While the green areas generally mean the part deformation is occurring within an acceptable level of severity for the material being formed. Different material types and thicknesses have different forming limits. Therefore these colors correlate to different strain levels based on the user defined material type and thickness. Traditionally this strain data is used only to determine the ability for the part to be formed by the tooling safely and with robust repeatability. The present application provides a system performing a new method for correlating the strain data to a resultant product model to visually depict surface roughness, cosmetic appearance or reflectivity.

### BRIEF DESCRIPTION OF DRAWINGS

FIG. 1 provides a flow chart, schematically depicting the method steps and system components use to perform the surface roughness determination of the present application;

FIG. 2 provides a partial computer software simulation to demonstrate the sequence of steps used to model product formation and deformation information;

FIG. 3 schematically illustrates the locations of material strain for which data measurements were taken prior to and after metal forming using the present method;

FIG. 4 partially illustrates a circle grid applied to a drawn dome test sample for measuring strain distribution using the present method;

FIG. 5 schematically illustrates the circle grid measurements taken after metal forming to determine the percentage change in the diameter in two directions;

FIG. 6 schematically illustrates the results of directional stretching which may be measured during the circle grid analysis;

FIG. 7 schematically represents a sample portion of a metal product with a circle grid following deformation of the metal material during forming;

FIG. 8 schematically illustrates the stretch data, the measurements from the circle, as graphical coordinates used to generate a forming limit diagram;

FIGS. 12a to 12d illustrates a comparison of 4 nickel-chrome plated manufactured products, with increasing plate thicknesses, shown with a red grid pattern, compared with their modeled graphical simulation image;

FIGS. 13a and 13b illustrate a grid pattern reflection in the product surface where the strain rate is high, and low, respectively;

FIG. 14a illustrates three grid pattern reflections in a product surface having a thin external surface treatment, and where the strain rate in the surface illustrated is high, medium and low, respectively;

FIG. 14b illustrates three grid pattern reflections in a product surface having a thicker external surface treatment, and where the strain rate in the surface illustrated is high, medium and low, respectively; and

FIGS. 15a to 15d schematically illustrates a simulated three dimensional computer model of a metal product produced using the system and method of the present application, with the model having strain related surface roughness characteristics on the model of the product, as it is estimated to appear after manufacture using the desired forming and coating of the product.

### DETAILED DESCRIPTION OF THE PRESENT SYSTEM

Turning now to the illustrations of the method and system of the present application, a flow chart of the method steps performed using the system is shown in FIG. 1.

Many metal components are formed which have cosmetic or performance requirements related to surface roughness. For example, exterior automotive body panels must meet what is termed Class A surface quality requirements. One requirement of a Class A surface is that it be smooth and have a relatively high level of specular reflectivity. Subsequent processes such as buffing, electroplating, painting and other coating processes are also required to achieve the required cosmetic appearance. By predicting the surface roughness of a metal component before the manufacturing process is tooled and engineered, or before the specific type of steel is selected for the product, time and money can be saved.

An additional application of the surface roughness prediction is to estimate the optical reflectivity of a steel surface. Automotive headlamps are comprised of a light source as well as a reflector. The reflector can be formed from steel and may take the shape of a smooth parabola or a concave surface with complex facets for producing specific reflections. A common requirement of the interior surface of the reflector is that its optical reflectivity is of a high enough value that the light is reflected efficiently and produces the required beam pattern as stated in National Highway Traffic Safety Administration Federal Motor Vehicle Safety Standards 108 and the comparable UN Economic Commission for Europe photometric requirements. Determining the surface roughness of the formed steel reflector provides the ability to calculate and estimate the reflectivity of that reflector for optical purposes.

At long light wavelengths, where λ>>σₐ^{M}, the diffusion reflectance is ignored and the surface reflectance R_{S} from the rough surface of the manufactured material with respect to a perfectly smooth surface R₀ of the same material is: R_{S}=R₀ exp[−(4πσ)²/λ²]; where a equals Root Mean Square Roughness. See, Bennett H. E, Porteus J O, Relation Between Surface Roughness and Specular Reflectance at Normal Incidence, Journal of the Optical Society of America, Volume 51, Number 2, February, 1961.

Using the above equation, the reflectivity of a steel reflector could be predicted if the surface roughness could be predicted. By predicting the surface roughness of a metal reflector before the manufacturing process is tooled and engineered or before the specific type of steel is selected for the product, time and money can be saved. Additionally, it can be determined if costly secondary coating processes will be necessary to achieve the required reflectivity for optical functionality of the reflector.

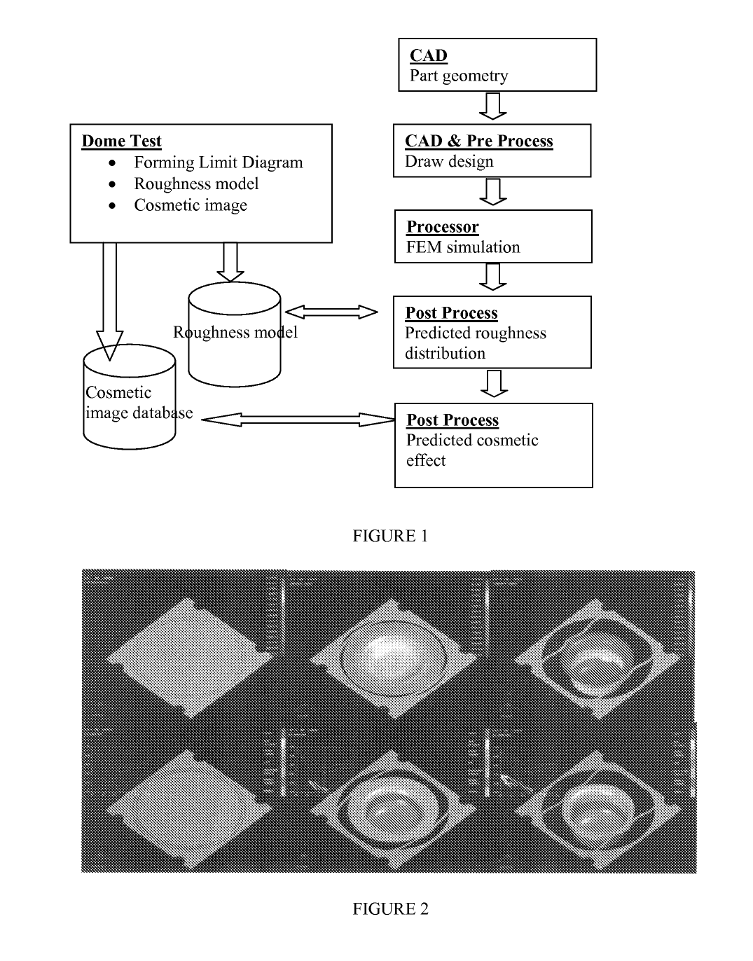

In the present system, commercially available computer aided design software is used which incorporates finite element analyses using commercially available finite element methodology software. The method used in the present application consists of several components. First, the computer aided design (CAD) software is used on a conventional computer system with a CPU unit, display and printing capacity. The CAD software is used to generate a database containing the geometry of the metal product or part to be manufactured. A pre-processing step is performed during which the mesh elements to be simulated and the related forces which will affect the simulation are created. A sample of the steps used in the simulation is shown in FIG. 2. Second, a solution step of the analysis is performed, during which a series of computations are made which simulate the interaction of forces and the mesh elements defined in the pre-processing step. The final stage is the post-processing step, during which the results are converted into interpretable data, usually making use of a color coded 3D image or other visual model.

In the current embodiment of the present system and method, a Dell Precision 390 Workstation with Dynaform FEA/FEM simulation software, offered by Engineering Technology Associates, Inc., are used to run the desired simulations, analysis and conversion. In the embodiment demonstrated, a vehicle bulb shield is the metal product being formed. There are many materials from which a vehicle bulb shield may be formed. The formability of the various materials may be simulated in the finite element modeling Dynaform software. The Dynaform software produces a graphical simulation showing three dimensional images of the metal product as it is formed and provides the local deformation information as a color graphic.

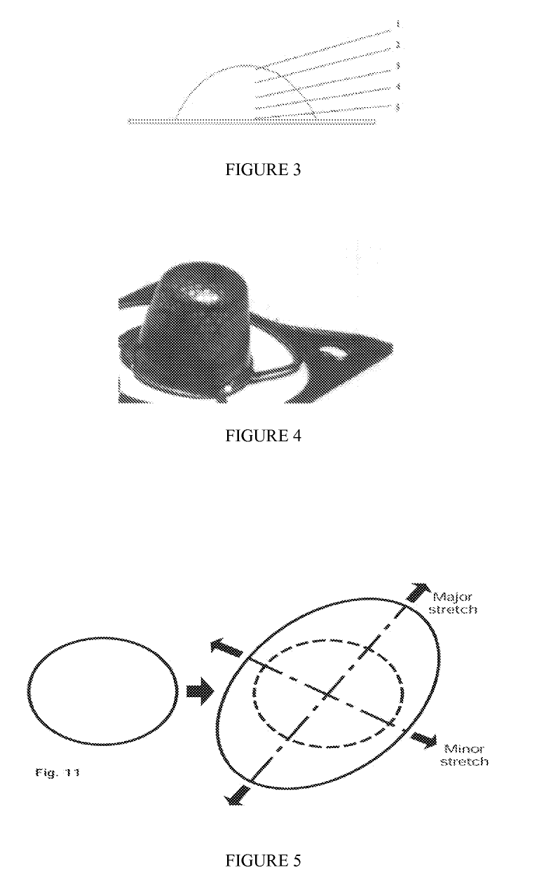

To generate the graphical simulation, a series of tests were performed with actual physical samples of a wide variety of commonly formed steel materials. Numerous strips of each type of steel were formed, using conventional metal drawing techniques, into domes. A dome is typically the shape used in vehicle bulb shields. Each sample of material was drawn in a forming tool. The materials were drawn until they fractured and/or provided locations for the strain to which the material was subjected during forming. The creation of the domes produced various levels of strain in the steels, generally as concentric bands around the circumference of the dome. The surface roughness of each steel material was known prior to forming. A second series of surface roughness tests were then performed on the steel materials at the various areas of localized strain after they were formed into the test sample. A surface profilometer was used to measure the steel's surface roughness before and after forming at five areas of known strain, which locations are shown in FIG. 3, and which were determined using a circle grid analysis of the test dome samples.

A circle grid analysis was then performed on the physical test dome samples of the drawn steel to verify strain distribution throughout the sample. A sample test dome having a circle grid is shown in part in FIG. 4. The concept of the circle grid analysis in metal forming was used to correlate the strain and surface roughness tests. First, a grid of circles is applied onto the surface of a test strip of steel material. The strip of steel material is deformed into the desired shape, in this case the dome, and then the circle grid is viewed to see how it has been deformed. Generally, the circles are measured to determine the percentage changes in diameter across two directions. The first direction is whatever direction the circle deformed the most, called the major stretch. The second direction measured is perpendicular to the major axis and termed the minor stretch. Samples of the major and minor stretches are shown in FIG. 5.

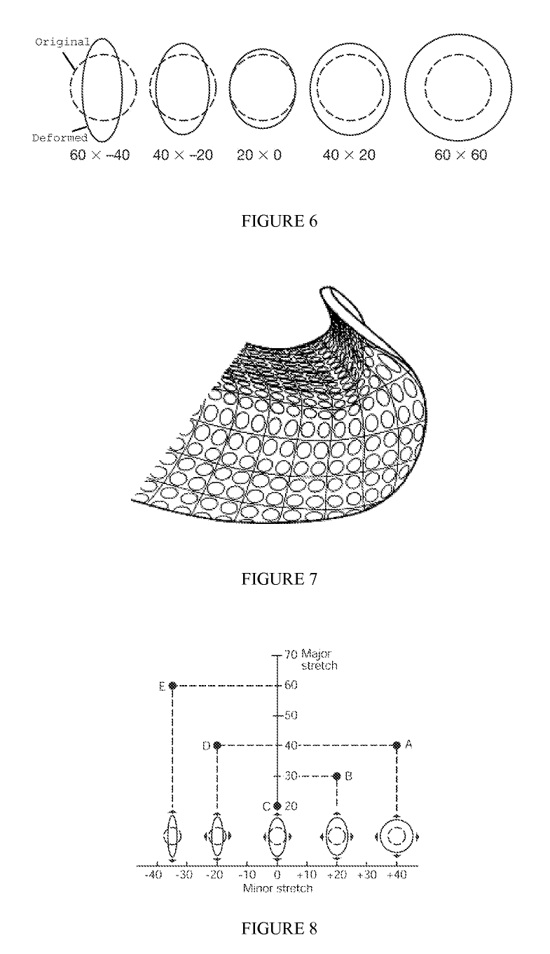

The circles of the grid can change shape in the variety of ways shown in FIG. 6. If the steel is being stretched in one direction and material is allowed to move in from the sides, the circle will become an oval with a thinner width than the original circle, like the circle at the far left in FIG. 6. If the circle is stretched equally in both directions the circle will become a larger circle, like the circle at the far right in FIG. 6. When a grid of these circles is placed on the steel to be tested, and then the steel is deformed as in FIG. 4, measurements can be made to determine where, and how much stretch, the steel material is being forced to endure during forming. A further sample of the circle grid deformation is shown in FIG. 7. The stretch data—the two measurements of each circle from the grid—are then used as the two value (x,y) coordinates on a graph, as shown in FIG. 8, where the coordinates shown include A-E. The graph is defined as the “forming limit diagram.”

Using the x,y pairs of selected circles on the domes surface, the localized strain at that area on the steel dome is known. Because the surface roughness of steel changes as it is stretched it is then possible to correlate the calculated strain value to a surface roughness value from the surface profilometer test data. During this stage of the process, the material type is known, as well as the localized strain distribution and the surface roughness at those localized strain areas.

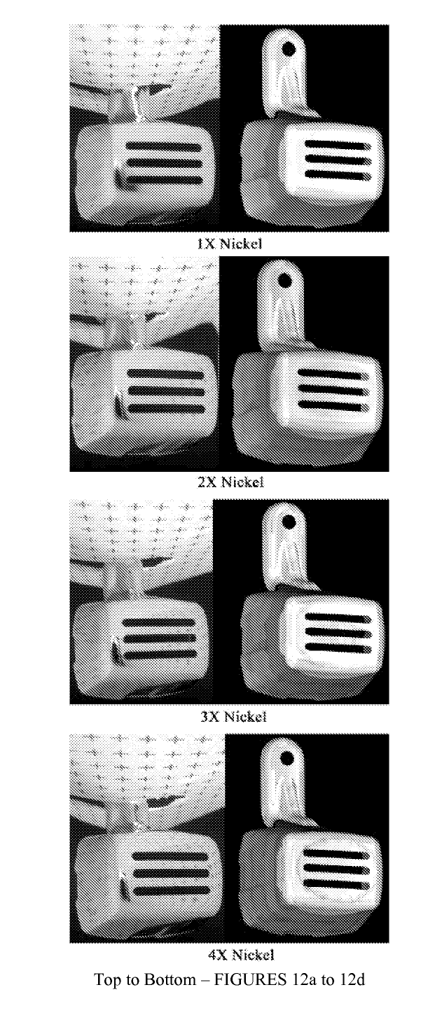

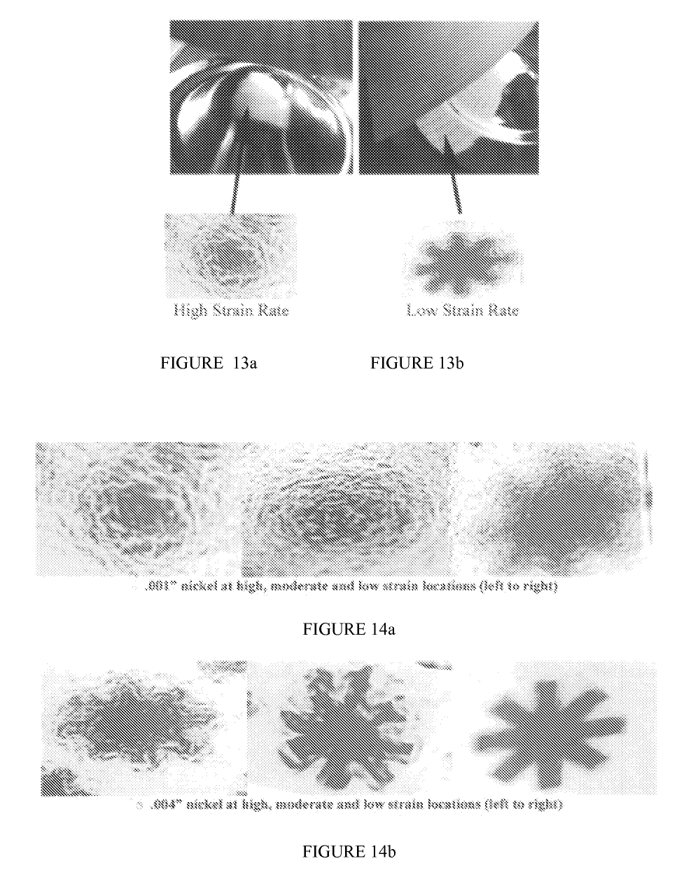

Each dome test sample from the variety of metal materials used was then sent to a nickel chrome plating facility where a decorative nickel chrome surface finish was applied to each dome sample. Specifically, four different thicknesses of nickel were applied to the various dome samples: 0.001 inch thickness to 0.004 inch thickness, as shown on the parts illustrated in FIGS. 12a to 12d, respectively. The electroplated domed samples with the decorative nickel chrome surface at various thicknesses were then placed proximate to a colored star shaped grid printed on photo paper. The star shaped red grid was placed proximate to the area to provide a consistent standard for surface reflectivity. This is also shown in FIGS. 12a, 12b, 12c and 12d, compared to the modeled part to be manufactured, as well as in FIGS. 13a and 13b and 14a and 14b. It should be understood that a variety of external surface finishes may be used to treat the metal product to be manufactured, involving metallizing or electroless plating, or numerous additional conventional surface treatments.

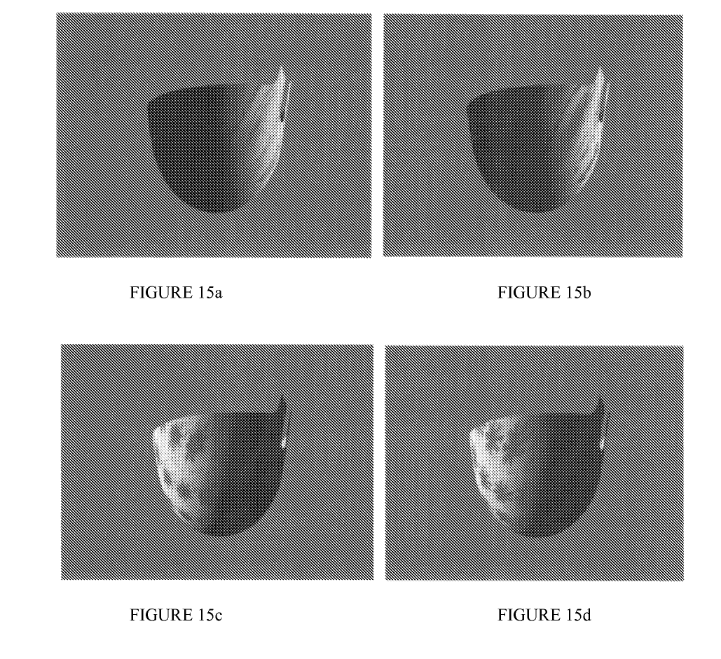

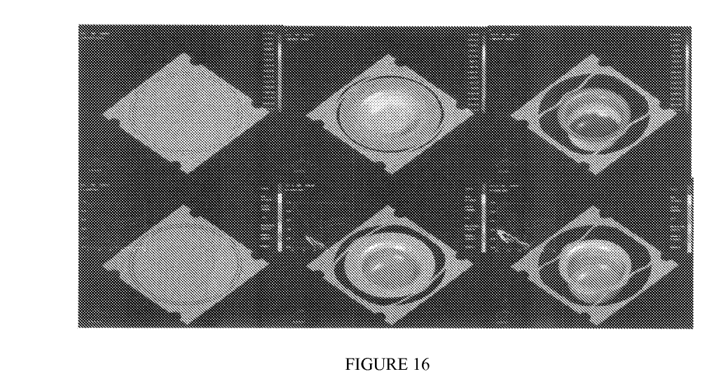

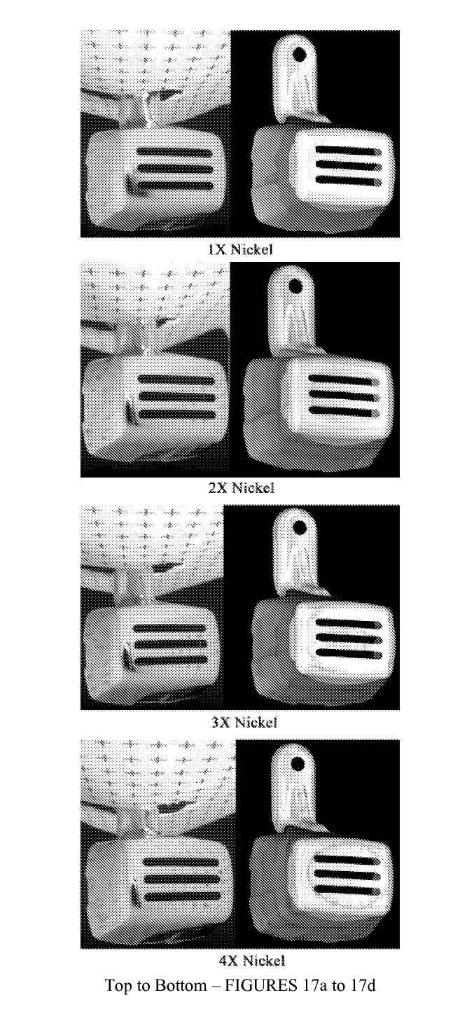

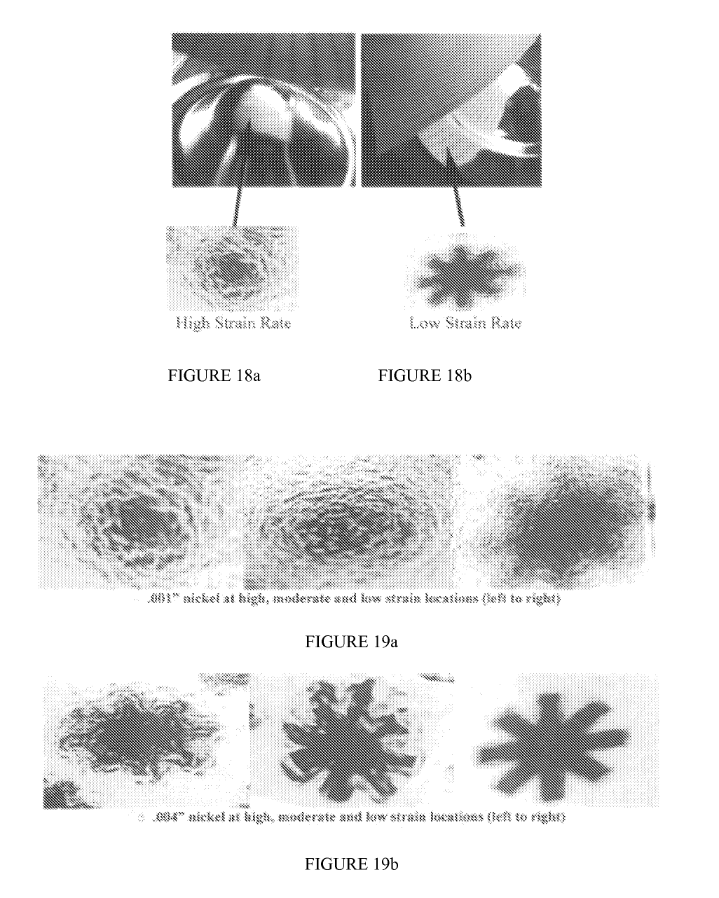

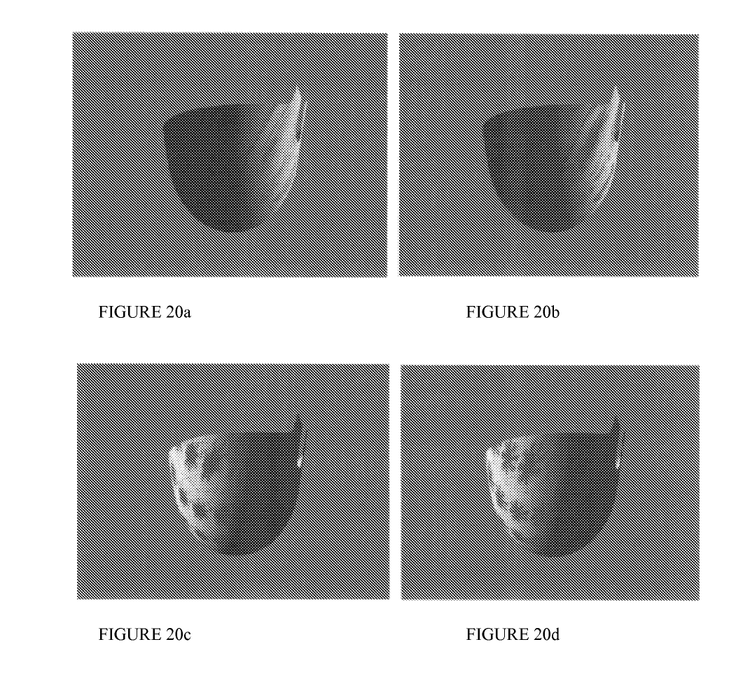

A 12.8 megapixel digital camera was used to create the photo images of the surface roughness. The degree to which the star shape can be resolved as a reflection on the steel surface indicates the quality of the surface. The colored images were then used to form a database or library, and placed on a three dimensional model as a surface texture in a CAD program, as shown in FIGS. 15a to 15d.

Using this data, a correlation between strain, surface roughness and reflectivity after nickel chrome plating, was determined. The library of photographs for various materials were created such that each image corresponds to a specific material at a specific strain rate with a specific amount of nickel chrome plating applied. These photographs can then be applied to a three dimensional model of the part as a visual texture map to simulate the visual appearance of the formed and electroplated part.

The metal product model is divided so that there are multiple sections, each section corresponding to a specific strain rate. These boundaries are derived from the result of the FEA/FEM simulation. Each section is then textured using a software program, such as ULead 3D Studio, with the corresponding image for strain and nickel chrome plating thickness. The result is a three dimensional part model which has the appropriate predicted cosmetic appearance covering the entire surface of the model. This secondary characteristic, surface roughness or reflectivity, is not considered in the typical FEM analysis but is useful to the metal product manufacturing industry.

Set forth below is a repetition of the series of steps performed in the method using the system of the present application for determining surface roughness. A three dimensional model of the tooling which will form the desired metal product is created using a computer aided design program. The tooling models are used in a finite element method analysis (FEM) to determine their impact on a flat strip of steel or other desired metal material (i.e. the material of the resultant formed product). The result of that FEM analysis is a three dimensional model of the formed part with the strain distribution data mapped on the product model. The amount of strain in the various regions of the part are correlated to a surface roughness by use of a table of data generated by actual experiments in which specific grades and finishes of steel materials were formed and were measured. Pictures taken of specific locations on the experimental dome test samples after being coated with a cosmetic finish (e.g. nickel-chrome electroplate, paint, anodize, or other conventional cosmetic metal finishes) are taken and correlated to the surface roughness of that location on the metal product model in the database. The result is an ability to match a predicted strain value for a specific steel material from an FEM simulation to a picture of the known resulting appearance. The appropriate strain reflection pictures are mapped onto a 3D model of the metal product to their respective locations and a three dimensional model of the product as it is estimated to appear after forming and coating is produced.

Improper material selection, improper estimation of required secondary finishing processes, or improper estimation of coating thickness requirements to achieve the desired cosmetic appearance of the component, are some of the features which can have a detrimental impact on the economic success of the manufactured part or component. The utilization of the above system and method for simulating surface roughness of a formed component can reduce those risks.

While embodiments of the invention have been described in detail herein, it will be appreciated by those skilled in the art that various modifications and alternatives to the system and method could be developed in light of the overall teachings of the disclosure. Accordingly, the particular devices and arrangements are illustrative only and are not limiting as to the scope of the invention which is to be given the full breadth of any and all equivalents thereof.

We claim:

1. A method for modeling surface roughness or cosmetic appearance in manufacturing of metal products comprising the steps of:
loading the desired dimensions of a product to be manufactured into a computer aided design program;
generating a computer aided design model of a product to be manufactured and predicted levels of strain associated with the product during its manufacture;
creating a database of material characteristics, including a digital image, resulting from physical testing of different desired materials to form the product to be manufactured;
superimposing the database of physical characteristics resulting from physical testing on the computer aided design model of the product to be manufactured of a desired material to produce a simulated product image; and
reviewing the simulated product image to determine whether potential problem areas may result from manufacture of the product from the desired material.

2. A system for modeling surface roughness or cosmetic appearance in manufacturing of metal products comprising:
a computer aided design program having the predetermined desired dimensions of a product to be manufactured loaded into a memory device;
a computer aided design model of a product to be manufactured and predicted levels of strain associated with the product during its manufacture;
a database of material characteristics, including a digital image, resulting from physical testing of different desired materials to form the product to be manufactured;
said database of physical characteristics resulting from physical testing, superimposed on the computer aided design model of the product to be manufactured of a desired material to produce a simulated product image; and
the simulated product image indicates potential problem areas resulting from manufacture of the product from the desired material.

3. The method of claim 1, wherein the step of creating a computer aided design model of a product to be manufactured includes predicted colored levels of strain associated with the product during its manufacture, with colors assigned to represent levels of strain.

4. The system of claim 2, wherein the database of material characteristics, includes a colored digital image, resulting from physical testing of different desired materials to form the product to be manufactured.
